(19) United States
(12) Patent Application Publication
(10) Pub. No.: US 2026/0110221 A1
(43) Pub. Date: Apr. 23, 2026

(54) JOINT FOR DOWNHOLE MOTOR

(71) Applicant: BICO Drilling Tools, Inc., Houston, TX (US)

(72) Inventor: David A. Bowar, Casper, WY (US)

(21) Appl. No.: 19/267,423

(22) Filed: Jul. 11, 2025

Related U.S. Application Data
(60) Provisional application No. 63/708,681, filed on Oct. 17, 2024.

(51) Int. Cl. E21B 17/02

(52) U.S. Cl. CPC E21B 17/02; E21B 17/03; F16D 3/18; F16D 3/48; E21B 4/02; F03B 13/02; F03C 2/08

(57) ABSTRACT

A joint for a downhole motor suitable for use in a wellbore, the joint having a first joint member that includes a shaft with a shaft end, and a second joint member coupled with the first joint member. A gear profile extends from the shaft end, and is configured to mate with a respective gear profile of the second joint member. The gear profile comprises a set of three gear teeth.

### STATEMENT REGARDING FEDERALLY SPONSORED RESEARCH OR DEVELOPMENT

Not applicable.

### BACKGROUND

### Field of the Disclosure

This disclosure generally relates to downhole tools and related systems and methods used in oil and gas wellbores. More specifically, the disclosure relates to a joint configuration useable with a downhole motor system, and methods pertaining to the same. In particular embodiments, the joint may include one or more components profiled in a manner to improve dissipation of operational stress and forces.

### Background of the Disclosure

An oil or gas well includes a wellbore extending into a subterranean formation at some depth below a surface (e.g., Earth's surface), and is usually lined with a tubular, such as casing, to add strength to the well.

The wellbore is routinely drilled by rotating a drillstring from the drilling rig, by means of a rotary table and kelly. The drill bit on the lowermost end of the drillstring is in turn rotated, and with the addition of weight applied to the drill bit by drill collars and other components of the drillstring, drilling takes place.

Another way of rotating the bit is by use of a downhole device, either a downhole motor, such as a positive displacement motor (frequently called a Moineau motor) or a downhole turbine. A “downhole motor” or “motor sub” as used herein, encompasses any arrangement that generates rotation of a downhole tool (such as a bit) and is positioned downhole in the drillstring.

When the downhole motor is used, the drillstring is not rotated; instead, the downhole motor utilizes circulation of a fluid, such as drilling fluid or “mud,” or in some cases gas, down through the drillstring and through the downhole motor, to generate torque and rotation, useful for efficient drilling of wells (often directional and horizontal). Although nomenclature may differ, a downhole motor is generally understood as a hydromechanical device placed on the end of a drillstring (or bottom hole assembly “BHA”), which helps in the drilling process by providing additional power to the drill bit.

Powered by the drilling fluid, the downhole motor converts hydraulic power into mechanical power, driving the drill bit to cut through the rock formations. FIG. 1 shows a conventional downhole motor 101 (as part of an overall drillstring 114 coupled with surface equipment). In operation, a power section 102 converts hydraulic horsepower (i.e., pump discharge) of drilling fluid to mechanical horsepower or also understood by those of skill in the art as rotational force. The rotational force is ultimately transferred to the bit 108 (such as at the bit box 110) so that the wellbore (not shown here) may be drilled.

The power section 102 is operatively connected (such as by threads) with one or more motor subs, such as a transmission section 104, a bent section 106, and a bearing section 107. The transmission section 104 commonly houses the drive shaft, and contains the high-pressure drilling fluid, air, or gas. If used, the bent section 106 makes the motor apparatus 101 steerable. The bearing section 107 contains the thrust bearings, upper radial bearings and lower radial bearings, and the like. Also, the bearing section 107 directs the drilling fluid, air, or gas to the drill bit 108 for removing cuttings, cooling, and lubricating the bit 108, among other things.

The power section 102 is the primary component for creating the pressure used to convert the hydraulic power from the drilling fluid into mechanical power. The transmission section 104 transfers the torque and rotation generated in the power section 102 to the drill bit 108. A conventional transmission section 104 consists of one or more (universal) joints, which allow the drill bit 108 to rotate and/or bend in different directions.

The current components used with the transmission section 104 have very limited useful life, with a relatively high usage cost and replacement cost. Reliability is somewhat questionable due to premature failures of the components. Load, torque, stress, etc. through the transmission section 104 are significant, and cause problems in operation related to the failures. Transmission failures are so frequent they are often considered a ‘consumable’ component.

Specifically to the joint, the rotational movement incurred was always thought of as just a rotation knuckle joint where the motion was not the main focus of the joint function; instead, the main focus was transferring the power “though” the joint, and let the rotational motion be as it is just to get the power transferred. Conventional joint design results in ‘point load’ that wears out the joint (or joint components) at a single point, and also fracture where the gear extends out (i.e., at the root radius).

There is a need in the art to improve reliability and operational function of downhole motors, especially in joints.

### SUMMARY

Embodiments of the disclosure pertain to a joint or coupling for a rotating member, such as a downhole motor. Aspects of the joint may include any of the following, such as a ‘tri-gear’ configuration.

In embodiments there may be a joint for a downhole motor transmission that includes a first joint member comprising a shaft with a shaft end; and a second joint member coupled with the first joint member.

There may be a gear profile that extends from the shaft end. The gear profile may be configured to mate with a respective gear profile of the second joint member. Any gear profile may include (or exactly include) a set of three gear teeth.

The set of three gear teeth may be arranged symmetrically, equidistantly, identically, etc. on the shaft end. The arrangement may be as viewed by one of ordinary skill in the art, with minor variation due to machine tolerance the like (and not microscopic precision).

In aspects, the shaft end may include a shaft face. An at least one of the set of three gear teeth may include a longitudinal tapered gear surface extending from a gear tooth root proximate the shaft face to a gear tooth edge. It may be the case that each of the set of three gear teeth may include a respective longitudinal tapered gear surface extending from a respective gear tooth root to a respective gear tooth edge. Any taper may have a taper angle in a range of at least one-half degree to no more than ten degrees with respect to a longitudinal reference axis. In aspects, the range may be at least one degree to no more than six degrees.

Any or all of the gear teeth may have a first outer gear face surface and a second outer gear face surface. With respect to a lateral axis, no respective first outer gear face surface and second outer gear face surface need have a planar surface reference lying parallel to another planar surface reference of any other first outer gear face surface or second outer gear face surface of any other of the set of gear teeth.

In aspects, any of the gear teeth may have a gear face pocket. In other aspects, there may be a gear pin disposed or otherwise engaged between the first joint member and the second joint member.

These and other embodiments, features and advantages will be apparent in the following detailed description and drawings.

### BRIEF DESCRIPTION OF THE DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIG. 1 is a simplified side view of a conventional downhole motor;

FIG. 2A shows an isometric view of a shaft end of a joint member according to embodiments of the disclosure;

FIG. 2B shows a side view of an upward facing shaft end according to embodiments of the disclosure

FIG. 2C shows a rotated side view of the shaft end of FIG. 2B according to embodiments of the disclosure;

FIG. 2D shows a rotated side view of a gear for the shaft end of FIG. 2B according to embodiments of the disclosure;

FIG. 2E shows a rotated side view of a plurality of gears for the shaft end of FIG. 2B according to embodiments of the disclosure;

FIG. 2F shows a lateral cross-sectional view of the shaft end of FIG. 2B according to embodiments of the disclosure;

FIG. 3A shows a side view of shaft ends configured to mate and form a joint according to embodiments of the disclosure;

FIG. 3B shows a longitudinal side cut cross-sectional view of a transmission section for a downhole motor system according to embodiments of the disclosure;

FIG. 3C shows a longitudinal side cut cross-sectional view of a gear pin for a joint according to embodiments of the disclosure;

FIG. 3D shows a longitudinal side view of a first joint member for the transmission section of FIG. 3B according to embodiments of the disclosure; and

FIG. 3E shows a lateral cross-sectional view of gears engaged to form a joint according to embodiments of the disclosure.

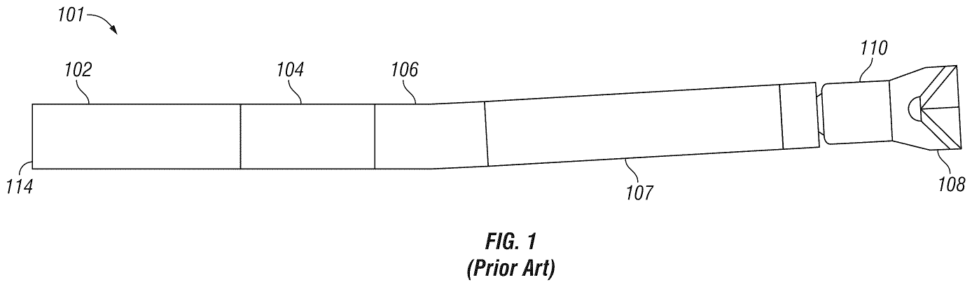

### DETAILED DESCRIPTION

Herein disclosed are novel apparatuses, systems, and methods that pertain to and are usable for wellbore operations, details of which are described herein.

Embodiments of the present disclosure are described in detail in a non-limiting manner with reference to the accompanying Figures. In the following discussion and in the claims, the terms “including” and “comprising” are used in an open-ended fashion, such as to mean, for example, “including, but not limited to . . . ”. While the disclosure may be described with reference to relevant apparatuses, systems, and methods, it should be understood the disclosure is not limited to the specific embodiments shown or described. Rather, one skilled in the art will appreciate that a variety of configurations may be implemented in accordance with embodiments herein.

Although not necessary, like elements in the various figures may be denoted by like reference numerals for consistency and ease of understanding. Numerous specific details are set forth in order to provide a more thorough understanding of the disclosure; however, it will be apparent to one of ordinary skill in the art that the embodiments disclosed herein may be practiced without these specific details. In other instances, well-known features have not been described in detail to avoid unnecessarily complicating the description. Directional terms, such as “above,” “below,” “upper,” “lower,” “front,” “back,” “right”, “left”, “down”, etc., are used for convenience and to refer to general direction and/or orientation, and are only intended for illustrative purposes only, and not to limit the disclosure.

Connection(s), couplings, or other forms of contact between parts, components, and so forth may include conventional items, such as lubricant, additional sealing materials, such as a gasket between flanges, PTFE between threads, and the like. The make and manufacture of any component, subcomponent, etc., may be as would be apparent to one of skill in the art, such as molding, forming, press extrusion, machining, or additive manufacturing. Embodiments of the disclosure provide for one or more components that may be new, used, and/or retrofitted.

Various equipment may be in fluid communication directly or indirectly with other equipment. Fluid communication may occur via one or more transfer lines and respective connectors, couplings, valving, and so forth. Fluid movers, such as pumps, may be utilized as would be apparent to one of skill in the art.

Numerical ranges in this disclosure may be approximate, and thus may include values outside of the range unless otherwise indicated. Numerical ranges include all values from and including the expressed lower and the upper values, in increments of smaller units. As an example, if a compositional, physical or other property, such as, for example, molecular weight, viscosity, temperature, pressure, distance, melt index, etc., is from 100 to 1,000, it is intended that all individual values, such as 100, 101, 102, etc., and sub ranges, such as 100 to 144, 155 to 170, 197 to 200, etc., are expressly enumerated. It is intended that decimals or fractions thereof be included. For ranges containing values which are less than one or containing fractional numbers greater than one (e.g., 1.1, 1.5, etc.), smaller units may be considered to be 0.0001, 0.001, 0.01, 0.1, etc. as appropriate. These are only examples of what is specifically intended, and all possible combinations of numerical values between the lowest value and the highest value enumerated, are to be considered to be expressly stated in this disclosure. Others may be implied or inferred.

Embodiments herein may be described at the macro level, especially from an ornamental or visual appearance. Thus, a dimension, such as length, may be described as having a certain numerical unit, albeit with or without attribution of a particular significant figure. One of skill in the art would appreciate that the dimension of “2 centimeters” may not be exactly 2 centimeters, and that at the micro-level may deviate. Similarly, reference to a “uniform” dimension, such as thickness, need not refer to completely, exactly uniform. Thus, a uniform or equal thickness of “1 millimeter” may have discernable variation at the micro-level within a certain tolerance (e.g., 0.001 millimeter) related to imprecision in measuring and fabrication.

### Terms

The term “connected” as used herein may refer to a connection between a respective component (or subcomponent) and another component (or another subcomponent), which can be fixed, movable, direct, indirect, and analogous to engaged, coupled, disposed, etc., and can be by screw, nut/bolt, weld, and so forth. Any use of any form of the terms “connect”, “engage”, “couple”, “attach”, “mount”, etc. or any other term describing an interaction between elements is not meant to limit the interaction to direct interaction between the elements and may also include indirect interaction between the elements described.

The term “mounted” as used herein may refer to a connection between a respective component (or subcomponent) and another component (or another subcomponent), which can be fixed, movable, direct, indirect, and analogous to engaged, coupled, disposed, etc., and can be by screw, nut/bolt, weld, and so forth.

The term “workstring” may refer to any type of device or tubular used in a wellbore. For example, a liner or liner string, tubestring, drillstring, a casing or casing string, etc.

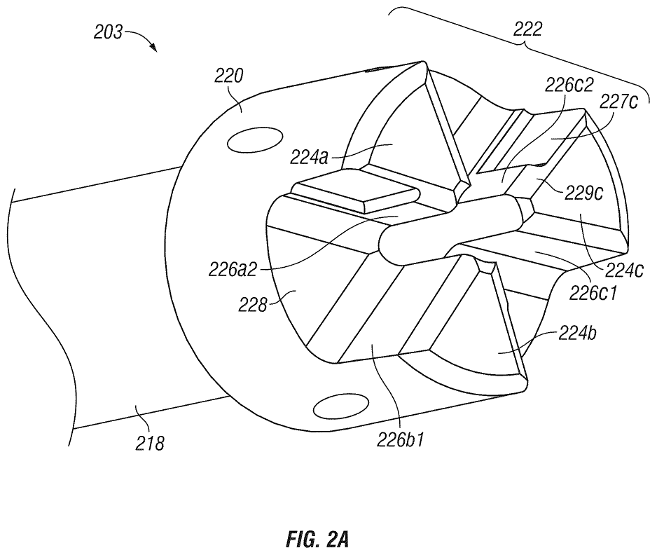

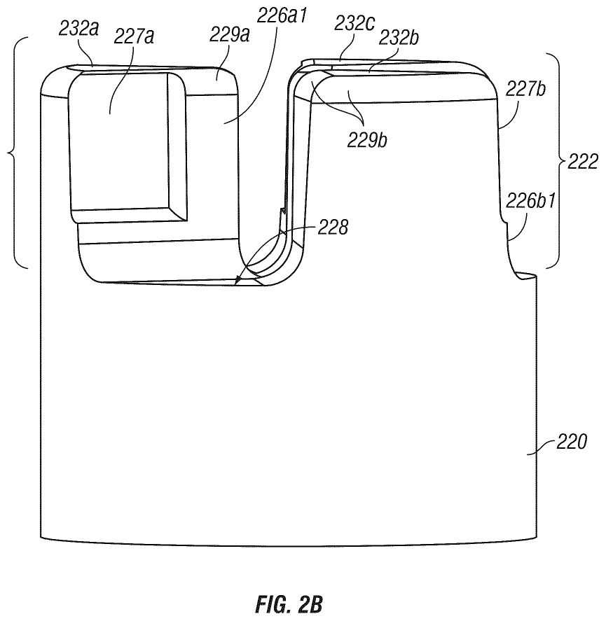

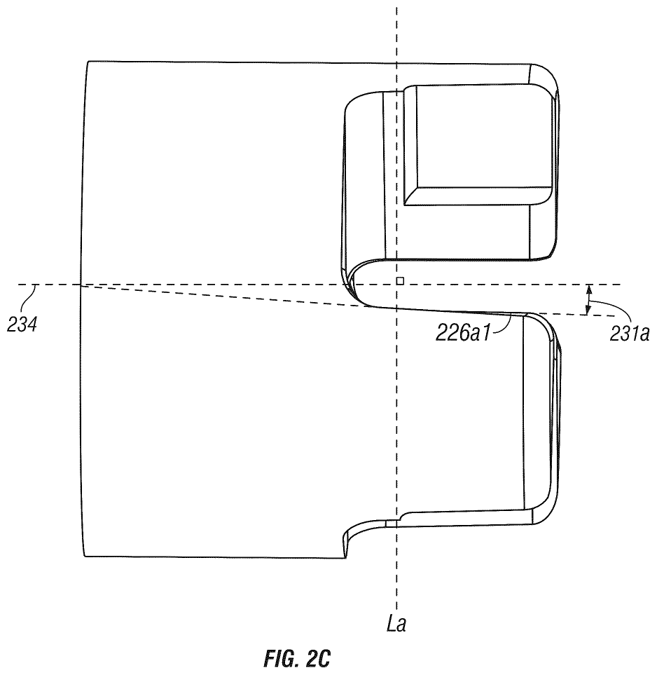

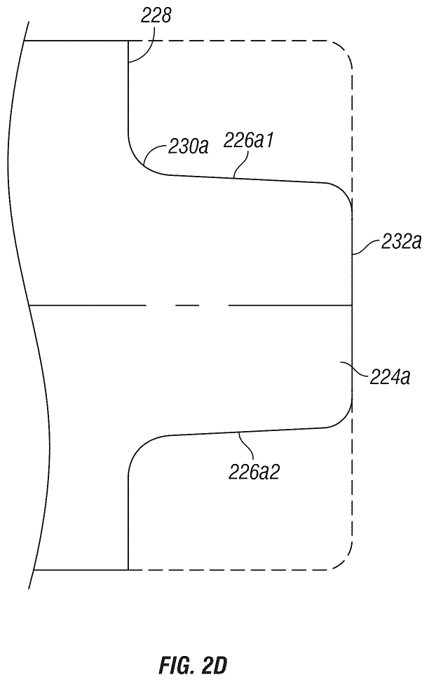

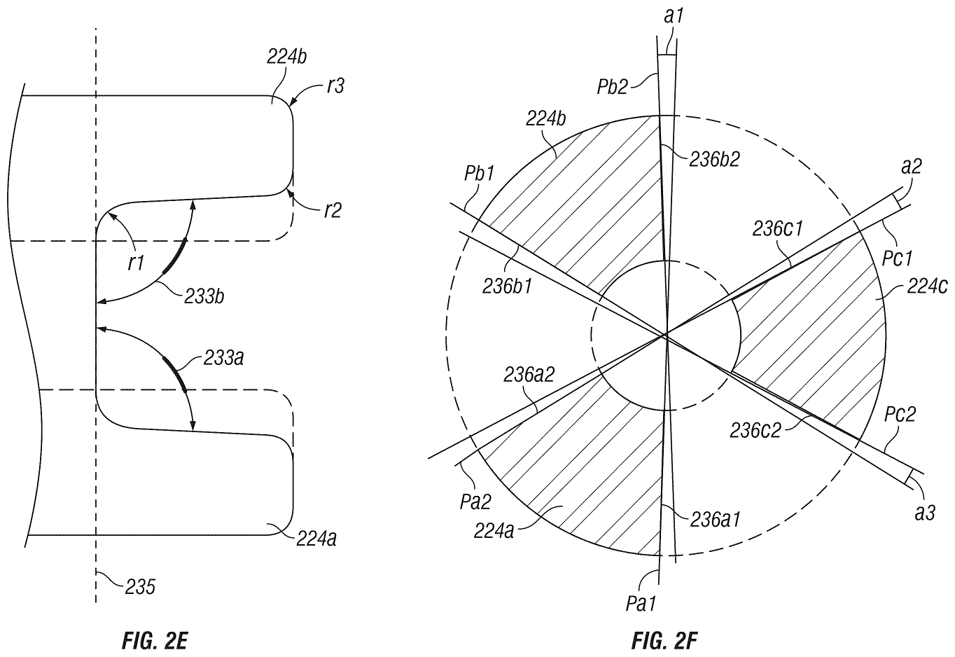

Referring now to FIGS. 2A, 2B, 2C, 2D, 2E, and 2F together, an isometric view of a shaft end of a joint member, a side view of an upward facing shaft end, a rotated side view of the shaft end, a rotated side view of a gear for the shaft end, a rotated side view of a plurality of gears for the shaft end, and a lateral cross-sectional view of the shaft end, respectively, in accordance with embodiments herein, are shown.

FIGS. 2A-2F together illustrate embodiments herein may provide for a joint member (or first, upper, lower joint member, etc.) 203, which may be elongated or shorter, depending on desired component operation or function. The joint member 203 may include a shaft 218 (shown only in part here) with a shaft end 220. One of skill would appreciate the shaft end 220 may be larger or oversized compared to the shaft (e.g., such as comparative diameters).

The shaft end 220 may have a shaft end or gear profile 222 which may entail a shaft end (planar) 228 face or surface with one or more gears or teeth 224a, 224b, 224c extending therefrom to respective gear ends 232a, 232b, 232c (forming respective valleys therebetween). Although shown here as three gears (or ‘tri-gear’), other numbers of gears may be used (two, three, four, etc.). Particular to the profile 222 shown here, the gears 224 a-c may be arranged symmetrically and with equidistant spacing therebetween, as well as a similar or exact overall general shape (within typical machine tolerance).

The first gear 224a may have a first gear face surface 226a1 and a second gear face surface 226a2. With the orientation shown, the first and second gear surfaces 226a1, 226a2 may be contemplated as sides or side surfaces. In a comparable manner, the other gears 224b, 224c may have their respective gear face surfaces (226b1, 226b2; 226c1, 226c2).

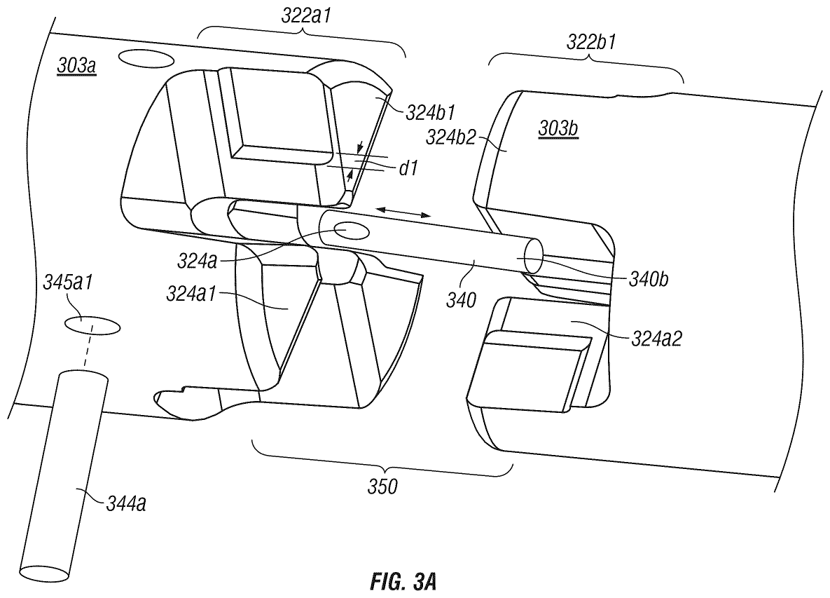

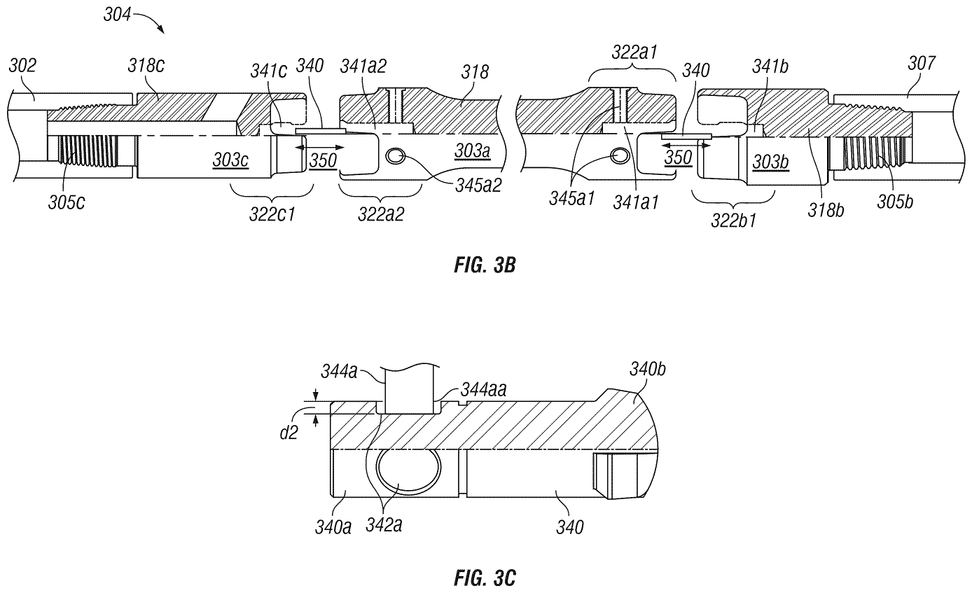

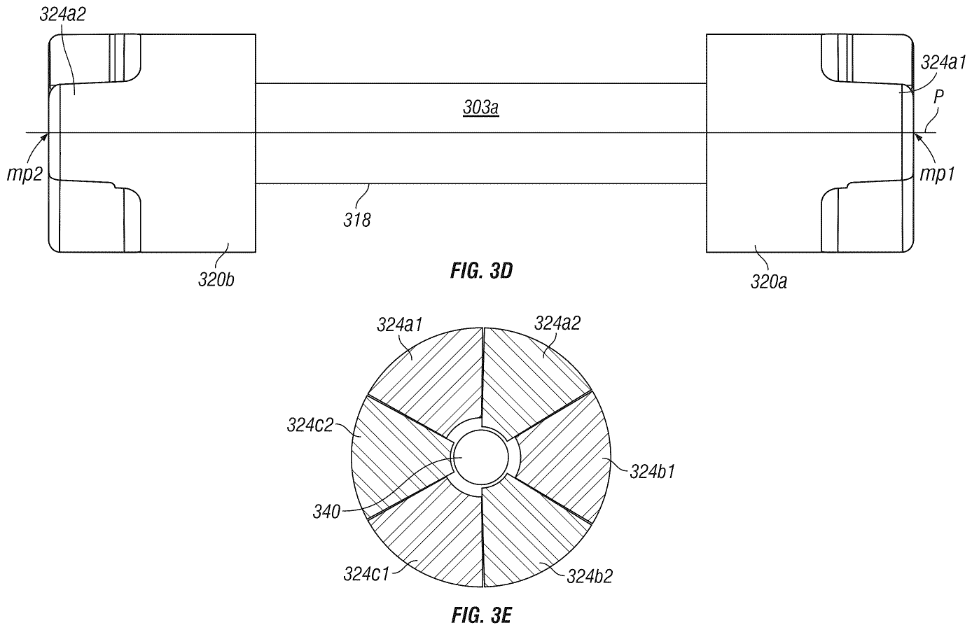

The first gear 224a may be configured with certain features, such as gear end edges 229a, which may be rounded (see, e.g., radius r2, r3, etc.). One or more of the surfaces 226a1, 226a2 may be milled or otherwise formed to have a pocket 227a. Although not limited to any particular type of shape, the pocket 227a may be squarish. The pocket 227a may be formed with a pocket depth (d1, FIG. 3A) suitable to accommodate placement of an insert (not shown here).

The insert may be hardened or suitable wear-resistant material, which may make the insert a sacrificial piece easily removed and replaced. The insert may be attached or coupled with the pocket 227a by known methods, such as press-fit, adhesive, weld, or the like. In a comparable manner, the other gears 224b, 224c may have respective pockets 227b, 227c (each may be configured with a respective insert), as well as edges 229b, 229c. An insert of a first tooth may face a respective insert of an opposite tooth, such as when a joint is made. Alternatively, respective (adjacent) inserts may face away from each other, and thus never come into contact.

Not limited to any particular orientation, the joint member 203 (or shaft end 220) may have a reference axis 234, which may be contemplated as a longitudinal reference axis. The reference axis 234 may be used for just that—to be a reference or highlight to certain characteristics or aspects of the member 203 (which may be surface or structural related). The reference axis 234 may be perpendicular to another axis La, which may be contemplated as a lateral (reference) axis (see also lateral reference 235).

The first gear face surface 226a1 may be oriented or configured at a longitudinal gear face angle 231a. The first gear face surface 226a1 may be akin to a tapered surface, which may be useful to help alleviate or mitigate stresses or loads incurred during gear interaction (e.g., during transmission rotation).

Generally, the surface 226a1 may be linear (or planar) from the root surface 228 to the edge 229a or end 232a. The surface 226a1 may be linear until merging or ending rounded surfaces (convex, concave, etc.) 229a (see r2, r3), 230a (see r1). In a similar manner the other (side) surface 226a2 of the gear 224a may have a comparable gear face angle. In embodiments, the angle of the surfaces 226a1, 226a2 to the reference axis 234 may be about equal. In certain embodiments, the angles may be exactly the same, such as about 5 degrees (subject to slight differences to typical machine tolerances of less than 0.5 degrees).

The angle 231a need not be limited, but may be in the range of about 0.5 degrees to about 10 degrees. In some aspects, the angle 231a may be about 4 degrees to about 6 degrees. With regard to lateral axis 235, there may be a respective angle 233a, noting that the surface 226a1 is the same surface, with the tapered nature of it the ‘angle’ may be a different value subject to the reference point utilized. It would be appreciated that the gears 224b, 224c may have comparable (angled) surfaces 226b1, 226b2; 226c1, 226c2 (see, e.g., 223b).

When the shaft end 220 is viewed on a lateral slice (such as along axis La; see FIG. 2F), the gear surfaces (or a point thereof) may be understood to lie in a plane. For example, the gear face surfaces 226a1, 226a2 of the first gear 224a may lie in respective planes Pa1, Pa2. In a comparable manner, gear face surfaces 226b1, 226b2; 226c1, 226c2 may lie in respective planes Pb1, Pb2; Pc1, Pc2. FIG. 2F illustrates that the points or surfaces lying in a respective plane may be angled or offset from any or all other of the reference planes (see offset angles a1, a2, a3). In a conventional joint, surfaces lie parallel, which leaves those surfaces susceptible to single point load wear and failure.

Referring now to FIGS. 3A, 3B, 3C, 3D, and 3E together, a side view of shaft ends configured to mate and form a joint, a longitudinal side cut cross-sectional view of a transmission section for a downhole motor system, a longitudinal side cut cross-sectional view of a gear pin for a joint, a longitudinal side view of a first joint member for the transmission section, and a lateral cross-sectional view of gears engaged to form a joint, respectively, in accordance with embodiments herein, are shown.

FIGS. 3A-3E together illustrate embodiments herein may provide for a joint(s) (or joint assembly, coupling, etc.) 350 that may be used with or for a transmission section (such as for a downhole motor) 304. The joint 350 may include a first or center joint member 303a that may be configured to engage with another component, such as a second (or lower, upper, etc.) joint member 303b. The second joint member 303b may be a sub or adapter.

The first joint member 303a may have a first shaft end 320a configured with a shaft end or gear profile 322a1, which may be like that of other profiles described herein (e.g., such as ‘tri-gear’ 222).

For the sake of brevity, similarities or differences readily apparent to one of skill in the art may not be explained in detail. In a similar manner, the second joint member 303b may also have a second or respective shaft end 320b with a gear profile 322b1. Coupling of the members 303a, 303b to form the joint 350 may result in engagement of the gears 324a1, 324b1, 324cl with respective gears 324a2, 324b2, 324c2 (see FIG. 3E). To aid coupling of the joint 350, a gear pin 340 may be disposed therebetween.

As shown in FIG. 3B, the transmission section 304 may include a plurality of joints 350 (shown unengaged here). Although the joints 350 may differ, FIG. 3B illustrates the duplicate nature that the transmission section 304 may have. Thus, the first joint member 303a may be coupled with the second joint member 303b on one side of the section 304, and the first joint member 303a may be coupled with another or upper joint member 303c on another side of the section 304. The upper joint member 303c may have a respective gear profile 322cl. One of skill would appreciate the likeness of the gear profiles 322c1, 322a2, etc.

The transmission section 304 may be coupled with other motor sections, such as a power section 302 and/or a bearing section 307 (other sections shown only in simplified representation). As such, the transmission section 304 may be used for a downhole motor of suitable type. For example, the lower joint member (or adapter, sub, etc.) 303c may have a respective shaft or body 318c with the gear profile 322cl on one side, but a coupling surface 305c on the other side. The coupling surface 305c may be threads (male or female), or any other type of feature useful for coupling the transmission section 304 with another motor section or component.

As also shown, the second or upper joint member (or adapter, sub, etc.) 303b may have a respective shaft or body 318b with the gear profile 322b1 on one side, but a coupling surface 305b on the other side. The coupling surface 305b may be threads (male or female), or any other type of feature useful for coupling the transmission section 304 with another motor section or component.

As mentioned, when the joints 350 are formed by engagement of the members 303a, 303b, 303c, there may be respective gear pins 340 used. The gear pins 340 may provide a degree of freedom of movement between knuckle end 340b and the respective end receptacles 341b, 341c. The other end 340a of the gear pin 340 may be configured with a pin slot (pocket, cavity, etc.) 342a. The other end 340a may be securingly disposed within member receptacles 341a1, 341a2.

The gear pin 340 may be configured with a plurality of pin slots 342a, such as about three. Any of the slots 342a may be machined or formed with a depth d2, which provides sufficient depth for an end 344aa of a securing member 344a to engage therein. The presence of the slots 342a at the depth d2 may help to alleviate stress otherwise incurred when a non-pocketed type surface is used. The respective securing member 344a may be inserted through an insert member hole 345a1, 345a2.

As shown in FIG. 3D, the center member 303a may have a symmetrical ‘in-phase’ configuration. The in-phase configuration may be defined by a plane or centerline through member 303a (or shaft 318) that results in a midpoint mp1 on one shaft side or end 320a lying in the same plane P as a midpoint mp2 on the other shaft side or end 320b. Although shown here as midpoints of respective gears 324a1, 324a2, it could just as well be midpoints of adjacent valleys.

While preferred embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the preferred embodiments of the present disclosure. The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A joint for a downhole motor transmission, the joint comprising:
a first joint member comprising a shaft with a shaft end;
a second joint member coupled with the first joint member;
wherein a gear profile extends from the shaft end, and is configured to mate with a respective gear profile of the second joint member,
and wherein the gear profile comprises a set of three gear teeth.

2. The joint of claim 1, wherein the set of three gear teeth are arranged symmetrically on the shaft end.

3. The joint of claim 1, wherein the shaft end comprises a shaft face, and wherein at least one of the set of three gear teeth comprises a longitudinal tapered gear surface extending from a gear tooth root proximate the shaft face to a gear tooth edge.

4. The joint of claim 1, wherein each of the set of three gear teeth comprise a respective longitudinal tapered gear surface extending from a respective gear tooth root to a respective gear tooth edge.

5. The joint of claim 4, wherein each of the respective longitudinal tapered gear surfaces comprises a taper angle in a range of at least one degree to no more than six degrees with respect to a longitudinal reference axis.

6. The joint of claim 1, wherein each of the set of three gear teeth comprise a first outer gear face surface and a second outer gear face surface, and wherein with respect to a lateral axis, no respective first outer gear face surface and second outer gear face surface has a planar surface reference lying parallel to another planar surface reference of any other first outer gear face surface or second outer gear face surface of any other of the set of three gear teeth.

7. The joint of claim 1, wherein each of the set of three gear teeth comprise a gear face pocket.

8. The joint of claim 1, wherein the shaft comprises an other shaft end, and another gear profile comprising a respective set of three gear teeth extending from the other shaft end, and wherein the set of three gear teeth is arranged in symmetrical phase to the respective set of three gear teeth.

9. The joint of claim 1, wherein a gear pin is engaged between the first joint member and the second joint member.

10. A joint for a downhole motor transmission, the joint comprising:
a first joint member comprising a shaft with a shaft end;
a second joint member coupled with the first joint member;
wherein a gear profile extends from the shaft end, and is configured to mate with a respective gear profile of the second joint member,
and wherein the gear profile comprises a set of gear teeth consisting of three gear teeth, and the respective gear profile comprises of a respective set of gear teeth consisting of three gear teeth.

11. The joint of claim 10, wherein the set of three gear teeth are arranged equidistantly on the shaft end.

12. The joint of claim 11, wherein the shaft end comprises a shaft face, and wherein at least one of the set of three gear teeth comprises a longitudinal tapered gear surface extending from a gear tooth root proximate the shaft face to a gear tooth edge.

13. The joint of claim 11, wherein each of the set of three gear teeth comprise a respective longitudinal tapered gear surface extending from a respective gear tooth root to a respective gear tooth edge.

14. The joint of claim 13, wherein each of the respective longitudinal tapered gear surfaces comprises a taper angle in a range of at least one degree to no more than six degrees with respect to a longitudinal reference axis.

15. The joint of claim 14, wherein each of the set of three gear teeth comprise a first outer gear face surface and a second outer gear face surface, and wherein with respect to a lateral axis, no respective first outer gear face surface and second outer gear face surface has a planar surface reference lying parallel to another planar surface reference of any other first outer gear face surface or second outer gear face surface of any other of the set of three gear teeth.

16. The joint of claim 15, wherein each of the set of three gear teeth comprise a gear face pocket.

17. The joint of claim 16, wherein a gear pin is engaged between the first joint member and the second joint member.

18. A joint for a downhole motor transmission, the joint comprising:
a first joint member comprising a shaft with a shaft end having a shaft face;
a second joint member coupled with the first joint member;
wherein a gear profile comprising a set of three gear teeth extends from the shaft end, and is configured to mate with a respective gear profile of the second joint member,
wherein at least one of the set of three gear teeth comprises a longitudinal tapered gear surface extending from a gear tooth root proximate the shaft face to a gear tooth edge,
wherein the longitudinal tapered gear surfaces comprises a taper angle in a range of at least one degree to no more than six degrees with respect to a longitudinal reference axis, and
wherein a gear pin is engaged between the first joint member and the second joint member.

19. The joint of claim 18, wherein each of the set of three gear teeth comprise a gear face pocket.

20. The joint of claim 19, wherein the shaft comprises an other shaft end, and another gear profile comprising a respective set of three gear teeth extending from the other shaft end, and wherein the set of three gear teeth is arranged in symmetrical phase to the respective set of three gear teeth.
